(19) United States
(12) Patent Application Publication
(10) Pub. No.: US 2015/0371416 A1
(43) Pub. Date: Dec. 24, 2015

(54) DRAWING APPLICATION FOR USE IN A COMMUNITY ENVIRONMENT

(71) Applicant: Garfield A. Lemonious, Detroit, MI (US)

(72) Inventor: Garfield A. Lemonious, Detroit, MI (US)

(21) Appl. No.: 14/746,741

(22) Filed: Jun. 22, 2015

Related U.S. Application Data
(60) Provisional application No. 62/015,617, filed on Jun. 23, 2014.

(51) Int. Cl. G06T 11/20; H04L 29/08; G06F 3/0484

(52) U.S. Cl. CPC G06T 11/203; G06F 3/04845; H04L 67/10

(57) ABSTRACT

The method enables drawing and captioning the images and then storing the images so they can be viewed, shared and voted on by members of a user group. Base line image data is presented to the user who is then challenged to incorporate to create a completed drawing image that includes the base line image data. The user can resize and reorient the base line image data as necessary. Drawings can be completed in either black-and-white or color, and are uploaded to a database for storage. The user develops creativity and artistic ability in interpreting how the shape or symbol can be incorporated into a new drawing.

### DRAWING APPLICATION FOR USE IN A COMMUNITY ENVIRONMENT

This application is related to and claims priority to U.S. Provisional Application No. 62/015,617, entitled “Drawing Application for Use in a Community Environment” by Garfield A. Lemonious, filed on Jun. 23, 2014.

### FIELD OF INVENTION

The present invention relates to a system and method for drawing, storing, and sharing images, and more particularly, completed drawing images including each including base line image data that has been provided

### BACKGROUND OF THE INVENTION

Even in the twenty-first century, freehand sketching remains a most useful tool for design exploration and graphic communication. Freehand sketching promotes creativity and is independent of language. Sketching is a form of architectural thinking.

Some relevant prior art involving freehand sketching includes the following:
U.S. Patent Document No. 20070231775 (Wagner) discloses an interpretive art workbook preferably having a front cover, a back cover and a plurality of sheets therebetween. A set of apertures are spaced apart and positioned along an edge of each sheet, the front cover and the back cover. Preferably, a binding, such as a spiral wire is passed through the apertures of each sheet and through the apertures of each cover. The binding binds the plurality of sheets between the front cover and the back cover to form the workbook. A free-form line drawing, preferably in bold print, is displayed on each sheet. The free-form line drawing is in the form of a scribble or squiggle and is suitable for interpretation and supplementation by an individual, typically a child. The interpretive art workbook can be used as an educational or entertainment device.
U.S. Patent Document No. 20130188877 (Gulwani et al.) discloses a sketch processing system for assisting a user in producing a drawing. In one implementation, the sketch processing system operates by: receiving ink strokes in response to creation of an original drawing; recognizing components and geometric constraints within the original drawing, to produce a recognized drawing; beautifying the original drawing by modifying at least one aspect of the recognized drawing in accordance with the recognized constraints, to produce a beautified drawing; and recognizing a recurring pattern in the beautified pattern (if any) and using that pattern to produce at least one added component to the beautified drawing.
U.S. Patent Document No. 20060227140 (Ramani et al.) discloses methods to provide for beautifying sketches. Methods are disclosed for determining segments of drawings that represent geometric primitives and implied geometric constraints. Beautification methods provide for replacement of sketched primitives and over- and under-sketched drawings. After beautification methods provide for checking the initial segmentation of the sketch to determine whether false segmentation points were identified. Methods are also disclosed to provide for searching of drawings based upon a beautified sketch. User interactivity is provided to further refine search results.
U.S. Pat. No. 8,145,545 (Rathod et al.) discloses a method of receiving input image data for an image search engine including providing a two-dimensional input image on a display screen, enabling a user to rotate the input image on the display screen about an axis that is non-perpendicular to a plane of the input image, and enabling the user to electronically draw modifications on the rotated input image.

Freehand sketching is generally a prescribed part of the studies of art students. Users can use freehand-sketching programs with minimal training. The freehand sketch is an effective way to communicate ideas.

What is needed is an application that encourages and enables users to develop their creativity by making freehand sketches using a predefined shape, symbol, or picture as the basis of the freehand sketches, in real time, and comparing such freehand sketches with others in friendly competitions. This will also provide cognitive stimulation and the development of artistic ability, while promoting a sense of community and enabling users to see things from the perspective of others. It is believed that by comparing and communicating in this manner, new friendships will develop and barriers will be broken down.

Sketching is a form of architectural thinking. What is needed is a system to encourage users to develop the ability to scale and visualize, develop artistic ability, and promote thinking and reasoning.

And, while some may lack the artistic skill or the patience needed to generate drawings using a digital surface, anyone can write a humorous or poetic caption for a drawing drawn by another. Some of these people have such a gift for poetry or humor that they need to be identified. By enabling such people to also participate ensures that everyone will engage in the group activity. The captions and the drawings present a competition for couples where one member of the couple may make the drawing and the other may generate the caption. Also, artists may submit a humorous or poetic caption for the drawing that he or she generates.

### SUMMARY OF THE INVENTION

The present invention addresses each of these needs.

The drawing application of the present invention enables an individual to be presented with a numbered shape, symbol or picture, and to complete a drawing with the shape, symbol or picture as the starting point based solely upon the interpretation of the individual. The completed drawing is then stored in a database. The means to access the completed drawings includes, but is not limited to, smart phones, tablet computers, websites, or hard copies, such as paper. If one uses a hard copy, the drawing can be converted to an electronic, computer-readable file using a scanner or any other existing technology which enables the creation of such files, in order to be uploaded and stored in the database. The drawings can be completed in both black-and-white and color, or just black-and-white, per the preference of the individual. If both black-and-white and color drawings are generated, the drawings are either stored in separate databases or stored in the same database and tagged as black-and-white and color.

The drawing application of the present invention takes advantage of social media networks (such as Twitter®, Facebook®, and Instagram®) to facilitate the creation of online communities. Users can challenge their friends in time-limited competitions, work cooperatively to produce a single drawing, or create their own starting shapes or symbols for their communities.

The drawings can be sorted by a number of criteria including, but not limited to, shape or symbol number, date uploaded and the geographic area of the user. Selected completed drawings in the database can be accessed by all users and voted on in daily, weekly or monthly competitions to select the groups' favorite.

In creating the drawing, each user may rotate the selected image (shape or picture) up to 360°, using the imagination to generate the drawing. A flip image is an option for an alternative embodiment, where a mirror image of the shape or picture of the original image is available. An erasure function is provided to erase any portion of the image drawn by the user. The user has access to a zoom function and can vary line thickness. Once completed, the drawing can be saved by the user to an electronic database.

For a complete understanding of the drawing application of the present invention for use in a community environment, reference is made to the following detailed description and accompanying drawings in which the presently preferred embodiments of the invention are shown by way of example. As the invention may be embodied in many forms without departing from the spirit of essential characteristics thereof, it is expressly understood that the drawings are for purposes of illustration and description only, and are not intended as a definition of the limits of the invention.

### BRIEF DESCRIPTION OF THE DRAWINGS

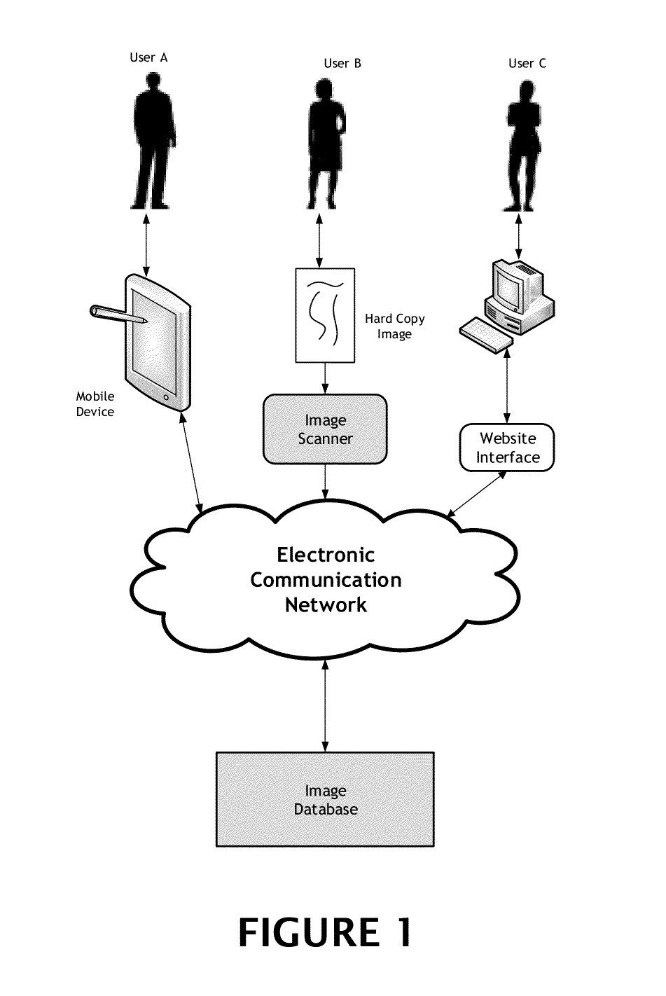

FIG. 1 is a simplified schematic of the preferred embodiment of the drawing application of the present invention for use in a community environment.

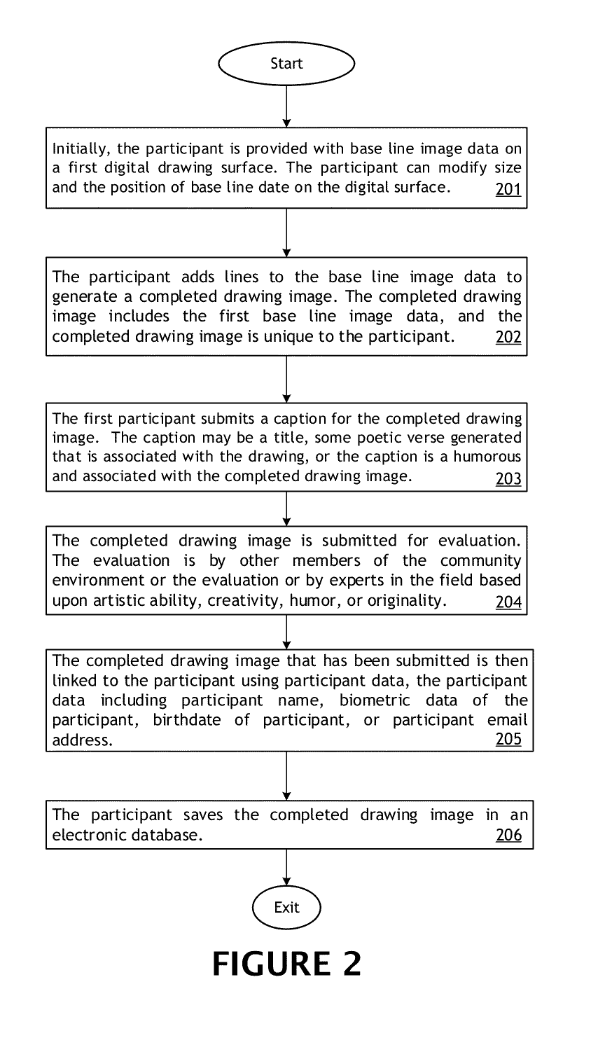

FIG. 2 depicts a block diagram of a first preferred embodiment of the drawing application of the present invention.

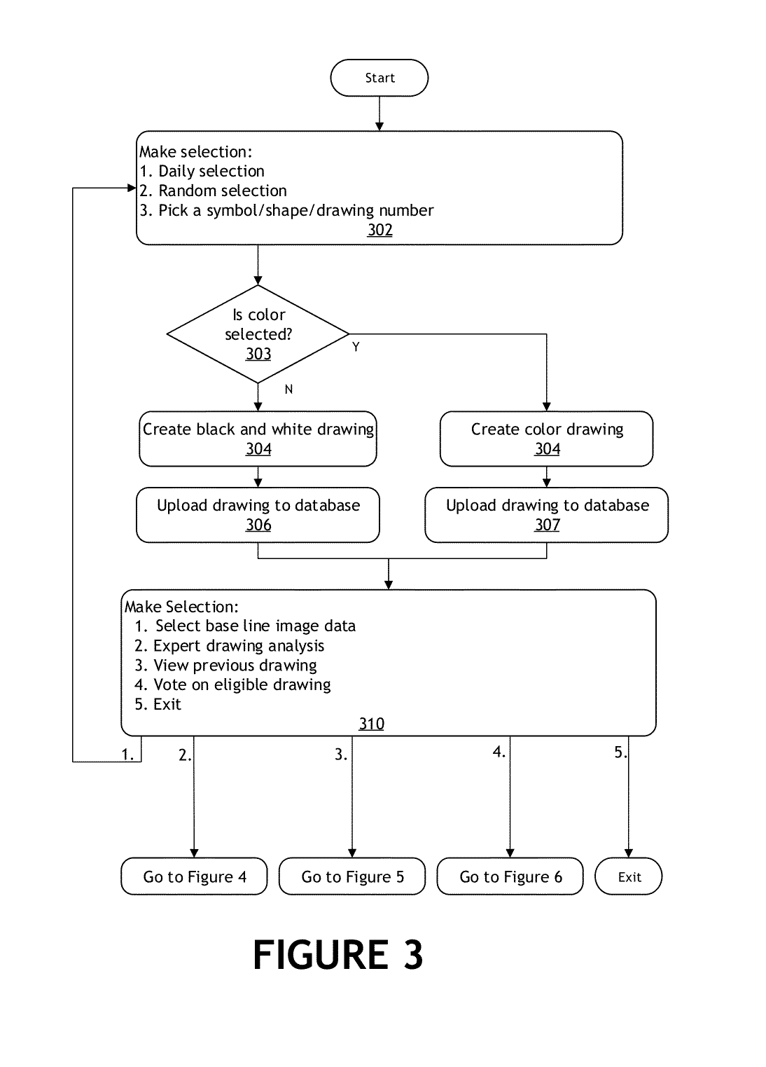

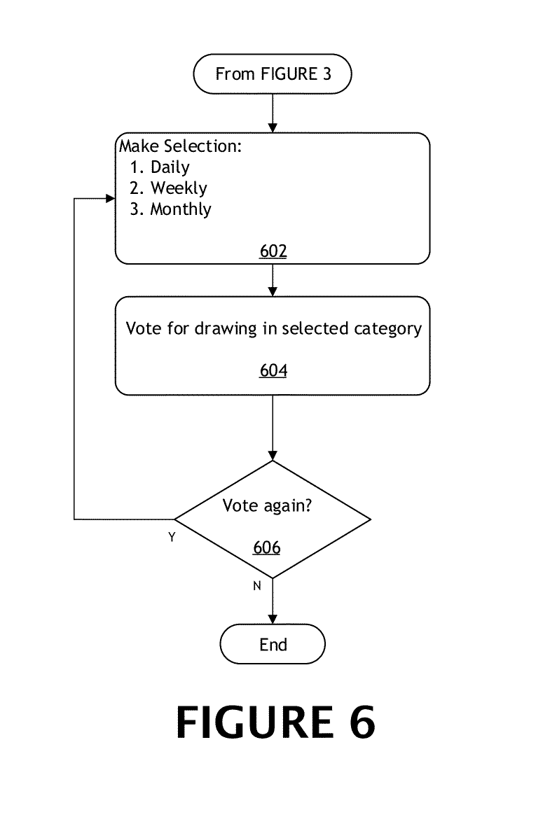

FIGS. 3 through 6 depict the sequence of action of various parts of the drawing application of FIG. 1.

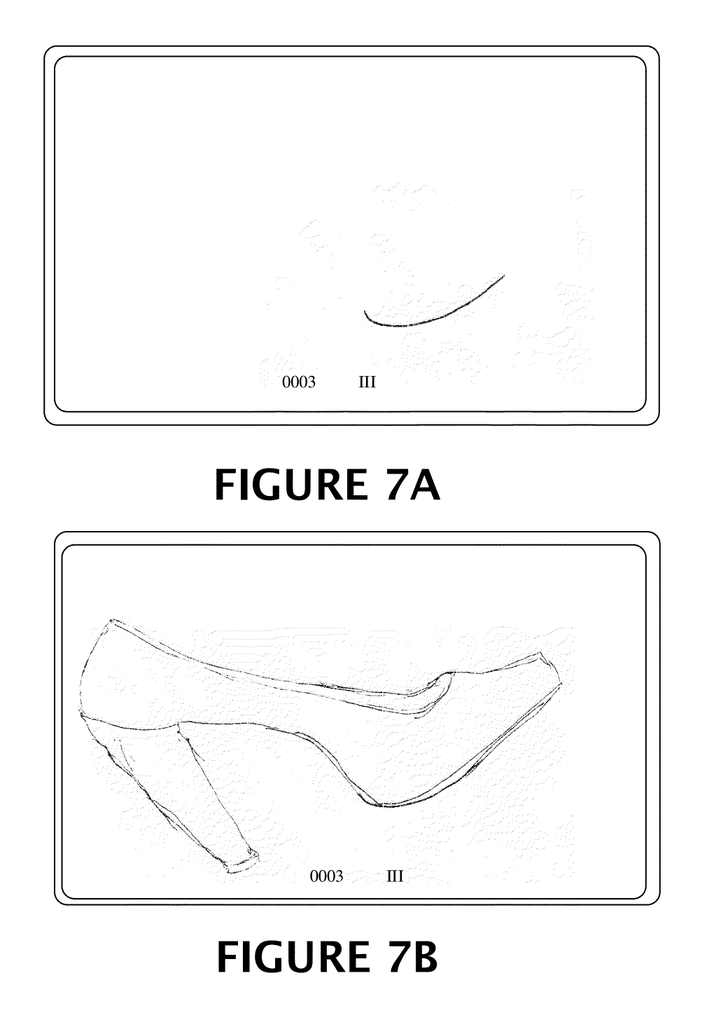

FIGS. 7A and 7B depict a before and after example of the drawing application of the present invention. FIG. 7A depicts the base line image data of a drawing. FIG. 7B depicts a completed drawing image that includes the base line image data of FIG. 7A.

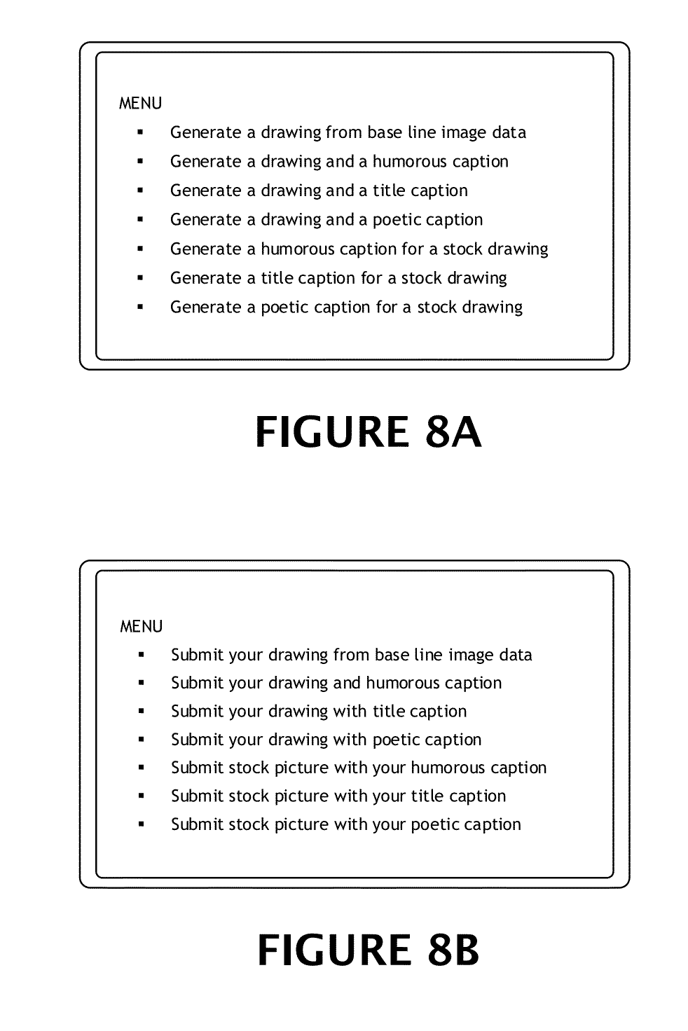

FIG. 8A depicts a simplified image of a “MENU” that is used by one using to select an option for generating a drawing, a caption or both using the drawing application of the present invention.

FIG. 8B depicts a simplified image of a MENU that is used for submitting a drawing, a caption, or both using the drawing application of the present invention.

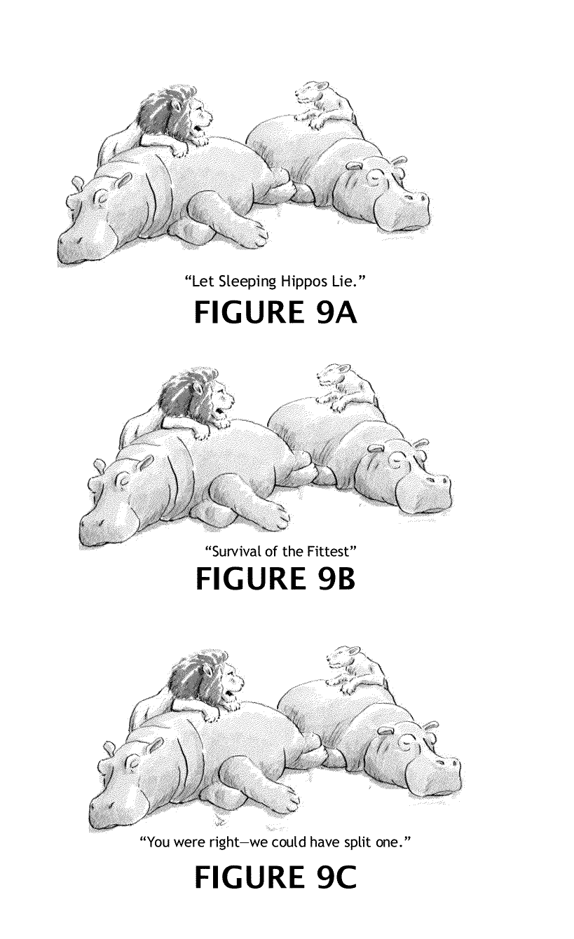

FIG. 9A depicts a simplified poetic caption submitted using the drawing application of the present invention.

FIG. 9B depicts a simplified title caption using submitted the drawing application of the present invention.

FIG. 9C depicts a simplified humorous caption submitted using the drawing application of the present invention.

### DETAILED DESCRIPTION OF THE PREFERRED EMBODIMENTS

Referring now to the drawings, FIG. 1 depicts a simplified schematic of the preferred embodiment of the drawing application of the present invention for use in a community environment.

The drawing application of the present invention is a graphical interface for creating drawings, uploading the drawings to a database and sorting the drawings based on user-chosen criteria. The database of drawings can be accessed by multiple users who can vote for their favorite drawings in periodically, and winners are selected at predetermined time intervals, such as daily, weekly or monthly.

When a user downloads the drawing application to her smart phone or tablet computer the user will be prompted to create an account and provide information including, but not limited to, a user name, age, location (city, state or province), e-mail address and password.

Once the user is logged in, the user will be prompted to create a new drawing, view previously created drawings, or vote on eligible drawings. To create a new drawing, the user can choose from the daily shape or symbol, a random shape or symbol, or select a shape or symbol from a list comprising a predetermined number of random selections or any shape or symbol that was a previous daily selection. Additionally, the user can choose to complete the drawing in black-and-white or color.

To participate in the program, the use initially makes a selection from a menu as to which option is to be selected. The menu generally comprises the following (and is depicted in FIG. 8A)
Generate a drawing from the base line image data
Generate a drawing and a humorous caption
Generate a drawing and a title caption
Generate a drawing and a poetic caption
Generate a humorous caption for a stock drawing
Generate a title caption for a stock drawing
Generate a poetic caption for a stock drawing

FIG. 2 depicts a block diagram of a first preferred embodiment of the drawing application of the present invention. Initially, the participant is provided with base line image data on a first digital surface. The digital surface is a smart phone, a digital computer drawing tablets or touchscreen tablets. The participant generates the drawing with either a stylus, his or her finger, or a combination of both. The participant can modify size and the position of the base line data on the digital surface [201]. The participant can add lines to the base line image data to generate a completed drawing image. The completed drawing image includes the first base line image data, and the completed drawing image is unique to the participant [202]. The participant can also submit a caption for the completed drawing image. The caption may be a title, some poetic verse generated that is associated with the drawing, or the caption is a humorous and associated with the completed drawing image [203]. The completed drawing image is submitted for evaluation. The caption is entered either by keystroke or by speech capture. The evaluation may be by other members of the community environment or the evaluation can be by experts in the field based upon artistic ability, creativity, humor, or originality [204]. One primary purpose of the drawing application of the present invention is to identify genius or gifted individuals at an early age so that such individuals can receive the training to fully develop such gifts. The experts are artists, writers, humorists, educators, or therapists, or any combination thereof. The completed drawing image that has been submitted is then linked to the participant using participant data, the participant data including participant name, biometric data of the participant, birthdate of participant, or participant email address [205]. The participant save the completed drawing image in an electronic database [206].

The user will have access to a number of tools built into the drawing application of the present invention to facilitate completion of the drawing. For example, the user will be able to rotate the page up to 360°, have access to an eraser function, be able to select a line thickness, and zoom in and out. If the user opts to create a drawing in color, the user will have access to a full spectrum of tints and shades and additional tools including colored markers and paint. The user will not be able to erase the initial shape or symbol, and the user can choose to have the initial shape or symbol highlighted to make it stand out from the rest of the drawing. In another preferred embodiment, the user can rotate the image a full 360° perhaps, clockwise or counterclockwise, or 180° clockwise and 180° counterclockwise. In yet another alternative embodiment, the size of the original image can be enlarged but not reduced.

The drawing activities are not limited to the drawing application on a smart phone or tablet computer. Paper copies can be printed from a website or taken from other printed media such as books, magazines and newspapers. If a drawing is made on paper it can be scanned or otherwise converted into a computer-readable image file.

Regardless of the medium used to create the drawing, once the drawing is completed, the drawing can be uploaded to one of two databases: a database for black-and-white drawings or a database for color drawings. When the user uploads the drawing, the user preferably includes certain information including the drawing title, the age of the user, the username or name or initials, the shape or symbol number, the e-mail address of the user, geographic location (city, state or province, and country), and the date of the drawing (the upload date can be used). If the user has an account, much of this information can be captured from said account, but if the user is uploading a scanned copy of a paper drawing, this information will preferably need to be submitted at that time. Alternatively, the user can opt to link to a social media account such as Twitter® or Facebook®.

Once the user has labored over the drawing, he or she can decide what to submit. Perhaps, the user may want to add a title or a humorous caption to the drawing. When ready to submit, a second menu is presented, and the user chooses what he or she would like to submit. (The menu is shown in FIG. 8B)
Submit your drawing from the base line image data
Submit your drawing and humorous caption
Submit your drawing with title caption
Submit your drawing with poetic caption
Submit stock picture with your humorous caption
Submit stock picture with your title caption
Submit stock picture with your poetic caption

FIGS. 3 through 6 depict the sequence of action of various parts of the drawing application of FIG. 1.

Once a drawing is uploaded, the drawing can no longer be edited. When the user logs in, the user can view drawings that are stored in the database [302], the user selects a drawing and opts for color or “black and white” [303 and 304], and uploads the drawing to his or her database [306 and 307].

Users can vote on drawings uploaded to the database in daily, weekly and monthly competitions. Voting for daily, weekly, and monthly competitions ends at a predetermined time and date, taking into account participants in varying time zones. Depending upon the number of participants and the size of the community, the top 5 or 5 percent for each time period can be selected.

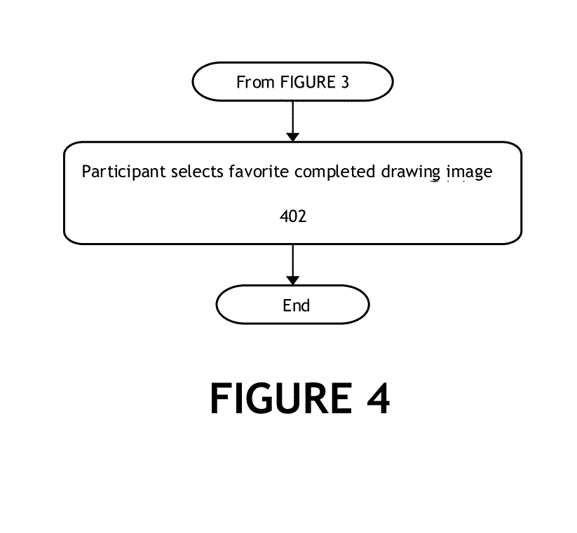

FIG. 4 shows a participant voting for a favorite drawing image [402]. Filter may be employed for a number of criteria including shape or symbol number, upload date and time, age or age group, and geographic area. Preferably, the participant is blocked from voting for his or her own drawings.

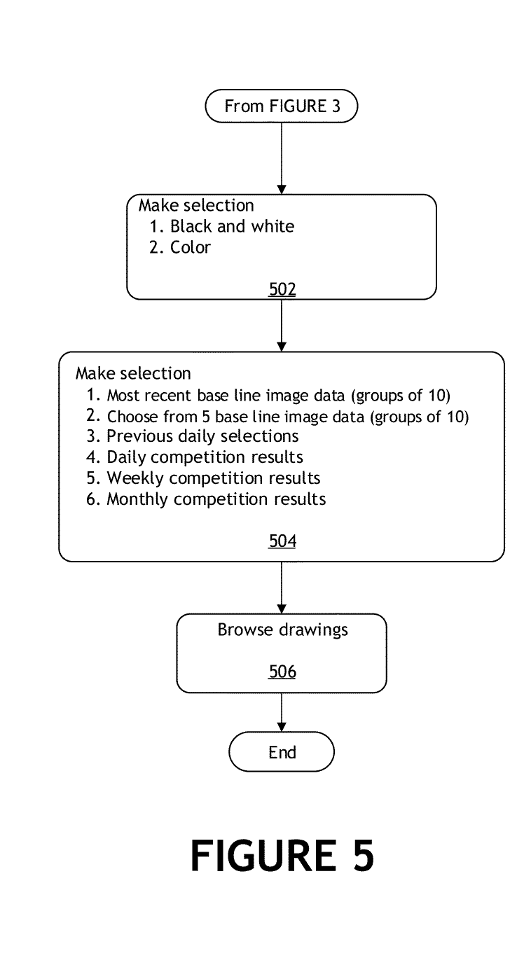

FIG. 5 depicts logic enabling the participant to view competition results [502, 504, and 506]. Entries for weekly competitions are determined by selecting the winner of the previous day's competition in addition to the top ten drawings from each day of the previous week, resulting in a pool of approximately 70 entries. Entries for monthly competitions are determined on the first day of each month by selecting the winner of the previous day's competition in addition to the top three drawings from each day of the previous month, resulting in a pool of approximately 90 entries. Competition winners could win prizes such as gift cards, coupon codes for online merchants, or cash. In yet still another embodiment, sponsors may be solicited for prizes for winners of the competitions.

The first base line image data is a plurality of straight lines, a plurality of curved or squiggly lines, a plurality of straight and curved or squiggly lines, a plurality of irregular or regular closed shapes with a plurality of curved lines and a plurality of straight lines. The closed shapes are one or more circles, ovals, loops, polygons, ellipses, teardrops, crescents, keyholes, hearts, pouches, or segments or any combination thereof.

Prizes are awarded to entrants based upon pre-determined criteria, such factors as artistic ability, creativity, originality, humor, time needed to create.

Also, the demographic data of the entrant is pertinent to any competition. One preferred embodiment of the drawing application of the present invention is for use in a classroom setting. In such a setting, all entrants would have the same time to complete his or her work, and the teacher or monitor is somewhat assured that the work is being done by each child of about the same age, rather than an older sibling. A 12-year old can generally do better work than an 8-year old, and so it would be unfair to the 8-year old to have to compete against entrants significantly older. If one purpose of the drawing program of the present invention is to recognize and reward talent, and perhaps even participant, than the entrants must be playing on a level playing field.

Since a team of people are more creative than only one person. In addition, a person or a team of people can be more creative the more time that they have. It would be highly unfair for the work of one person to be evaluated and compared against the work of a team of people who worked on the drawing and caption, perhaps, three times as long. Accordingly, in the preferred embodiment of the drawing application of the present invention, the participants compete in a classroom, a meeting room, a group-type session, or some other type of community environment with a teacher or some type of monitor present to confirm that the playing field is level for all. A second preferred embodiment pits couples or small groups of players against each other. One member on the team is responsible for generating the drawing and one or more members of the team are responsible for generating the caption.

A third preferred embodiment is an online chatroom or social networking website. Then, afterwards, the participants can present and discuss their work products to the other members of the group. Users can also create communities around the drawing application of the present invention on social media networking sites (such as Twitter®, Facebook®, and Instagram®). Members of communities can challenge each other to time-limited competitions (for example, complete a drawing in 2, 5 or 30 minutes). Community members can also collaborate on drawings in different ways, such as taking turns adding a line to the drawing, each person completing half of a drawing, etc. Users can also invite friends to join and gain access to unreleased shapes or symbols to work on, or follow users whose work they particularly like. Users can also suggest and submit shapes to use for drawings.

Another preferred embodiment involves a Sudoku-type game that is played on a computer (such as a pc, a handheld or laptop) or the Sudoku-type game can be distributed in daily newspapers or sold in paperbacks. It is envisioned that the drawing application of the present invention will be an excellent tool to be used by therapists working with people with personality disorders and victims of abuse, diagnosing the progress they are making in their treatment.

As used herein, participant data is data used to link the participant to the completed drawing submitted. The participant data includes the participant's name, home address, email address, biometric data, birthdate, birthplace, phone number, and the like. Biometric data, such as by non-limiting example, are fingerprints, voiceprints, facial imaging, eye scans (retinal or iris), keystroke pattern recognition, DNA, and the like.

Yet still another embodiment of the drawing application involves calligraphy. A word or short phrase is provided and participants write the word or short phrase in a unique font for review and consideration. In one preferred embodiment of this calligraphy variation, participants submit an ambigram. An “ambigram” is a word, art form or other symbolic representation, whose elements retain meaning when viewed or interpreted from a different direction, perspective, or orientation. The meaning of the ambigram may either change, or remain the same, when viewed or interpreted from different perspectives. Most commonly, the ambigram reads the same word or phrase when inverted. Another variation of an ambigram is a completely different word or phrase is read when the ambigram is inverted. Other variations of ambigrams are the word or phrase is can be read in a mirror image, either being the same word or phrase or a completely different word or phrase. Many images of ambigrams can be found online using the Bing® search engine.

Throughout this Application there are various Patents and Patent Applications referenced by number and inventor. The disclosures of these Patents and Patent Applications in their entireties are hereby incorporated by reference into this specification in order to more fully describe the state-of-the-art.

It is evident that many alternatives, modifications and variations of the drawing application of the present invention will be apparent to those skilled in the art in light of the disclosure herein. It is intended that the metes and bounds of the present invention be determined by the appended claims rather than by the language of the above specification, and that all such alternatives, modifications and variations which form a conjointly cooperative equivalent are intended to be included within the spirit and scope of these claims.

I claim:

1. A method for creating drawing images unique to a first participant, said method comprising:
a. providing said first participant with first base line image data, said first base line data having size and position on a first digital surface;
b. enabling said first participant to add lines of said first participant to said first base line image data to generate a first completed drawing image, said first completed drawing image including said first base line image data, said first completed drawing image being unique to said first participant;
c. submitting said first completed drawing image for evaluation, said evaluation being based upon artistic ability, creativity, or originality;
d. linking said first completed drawing image that has been submitted to said participant using participant data, said participant data including participant name, participant biometric data, birthdate of participant, or participant email address; and
e. enabling said first participant to save said first completed drawing image in a first electronic database.

2. The method of claim 1, wherein said first base line image data is a group of lines selected from the group consisting of a plurality of straight lines, a plurality of curved or squiggly lines, a plurality of straight and curved or squiggly lines, a plurality of irregular or regular closed shapes with a plurality of curved lines and a plurality of straight lines.

3. The method of claim 1, further comprising enabling said first participant to each rotate said position and said size of said first base line image data on said digital surface.

4. The method of claim 1, wherein said participants work in a community environment with a monitor present.

5. The method of claim 1, further comprising submitting said first completed drawing image and a caption to said processor for comparison with other drawing images generated from said first raw image data, said caption being verbiage associated with said completed drawing image.

6. The method of claim 5, wherein said caption is humorous verbiage associated with said first completed drawing image.

7. The method of claim 5, wherein said caption is poetic verse or title associated with said completed drawing image.

8. A method for creating drawing images unique to a first participant, said method comprising:
a. providing said first participant with first base line image data on a digital surface, said first base line data having size and position, said size and said position of said first base line data on a first digital drawing screen of said first participant being modifiable by said first participant;
b. enabling said first participant to add lines to said first base line image data of said first participant to generate a first completed drawing image, said first completed drawing image including said first base line image data, said first completed drawing image being unique to said first participant;
c. linking said first completed drawing image that has been submitted to said participant using participant data, said participant data including participant name, participant biometric data, birthdate of participant, or participant email address; and
d. enabling said first participant to save said first completed drawing image in a first electronic database, said first completed drawing image being identifiable in said first electronic database to said first participant;
whereby said participant is a member of a community environment, other members of said community environment also submitting completed drawing images, all of said members who submit a completed drawing image selecting a best drawing.

9. The method of claim 8, wherein said first base line image data is a group of lines selected from the group consisting of a plurality of straight lines, a plurality of curved or squiggly lines, a plurality of straight and curved or squiggly lines, a plurality of irregular or regular closed shapes with a plurality of curved lines and a plurality of straight lines.

10. The method of claim 9, further comprising enabling said first participant to rotate said position and said size of said first base line image data on said digital surface.

11. The method of claim 9, wherein said participants work in a community environment with a monitor

12. The method of claim 9, further comprising submitting said first completed drawing image and a caption to said processor for comparison with other drawing images generated from said first raw image data, said caption being verbiage associated with said completed drawing image.

13. The method of claim 12, wherein said caption is humorous verbiage associated with said first completed drawing image.

14. The method of claim 12, wherein said caption is poetic verse or title associated with said completed drawing image.

15. The method of claim 12, wherein said first participant generates a drawing and a second participant generates a caption.

16. A method for creating drawing images unique to a first participant, said method comprising:
a. providing said first participant with first base line image data on a first digital surface, said first base line data having size and position, said size and said position of said first base line data on said digital surface being modifiable by said first participant;
b. enabling said first participant to add lines to said first base line image data of said first participant to generate a first completed drawing image, said first completed drawing image including said first base line image data, said first completed drawing image being unique to said first participant;
c. enabling said first participant to submit a caption for said first completed drawing image, said caption being verbiage associated with first said completed drawing image;
d. submitting said first completed drawing image for evaluation, said evaluation being based upon artistic ability, creativity, humor, or originality;
e. linking said first completed drawing image that has been submitted to said participant using participant data, said participant data including participant name, participant biometric data, birthdate of participant, or participant email address; and
f. enabling said first participant to save said first completed drawing image in a first electronic database.

17. The method of claim 16, wherein said first base line image data is a group of lines selected from the group consisting of a plurality of straight lines, a plurality of curved or squiggly lines, a plurality of straight and curved or squiggly lines, a plurality of irregular or regular closed shapes with a plurality of curved lines and a plurality of straight lines.

18. The method of claim 16, wherein said participants work in a community environment with a monitor present.

19. The method of claim 16, further comprising enabling said first participant to erase any said lines generated by said first participant.

20. The method of claim 16, further comprising enabling said first participant to adjust a width and color of any line added to said first base line image data.
